(19) United States
(12) Patent Application Publication
(10) Pub. No.: US 2010/0019905 A1
(43) Pub. Date: Jan. 28, 2010

(54) System for inventory tracking and theft deterrence

(76) Inventors: John Bennett Boddie, Singapore (SG); Peter A. Bonee, JR., San Jose, CA (US); Bradley Alan Gambill, Baltimore, MD (US); Alasdair Charles Farquharson Trotter, Alexandria, VA (US)

Correspondence Address: George R. Schultz;Schultz & Associates, P.C., One Lincoln Centre, 5400 LBJ Freeway, Suite 1200, Dallas, TX, 75240, US

(21) Appl. No.: 12/220,699

(22) Filed: Jul. 25, 2008

(51) Int. Cl. G08B 13/14; G06Q 10/00

(52) U.S. Cl. 340/572.1; 705/28

(57) ABSTRACT

The invention disclosed provides a system for theft deterrence in a retail establishment having an inventory control system, a set of transceiver enabled storage units, and a set of RFID tags placed on stocked items. A stream of system logs and system alarms is compiled by a centralized computer which executes inventory database updates under normal inventory movement through a typical business cycle. The inventory is tracked from reception, to storage areas, to service areas, to point of sales. The system alerts operations management when abnormal inventory removal is detected. As the inventory moves from storage areas to service areas, the items are associated to a person and tracked until the inventory is properly checked in at its intended destination. The items may be associated to employees via a continuously monitoring video surveillance system, smart card identification system, or RFID tags on each person containing identification and credential information.

### FIELD OF INVENTION

The present invention relates generally to the field of inventory tracking systems and more specifically to the application of RFID tagging technology to affect theft deterrence in restaurants and other retail establishments that serve alcoholic beverages.

### BACKGROUND OF THE INVENTION

Theft deterrence in retail establishments continues to be an ongoing problem regardless of the presence of electronically active surveillance EAS and more recently RFID technology, although both of these technologies have provided real improvement. One class of theft deterrence is that of detecting and controlling shoplifting activity. The art of theft deterrence utilizing RFID technology in the case of shoplifting is well developed with the use of RFID tags embedded into products and embedded into RFID readers, often situated around the retail store and at exit points. Additionally, RFID tags may be fairly easily written to receipts so that systems may correlate purchased products with scanned RFID tags at exit locations. Generally, RFID tagging and reading has been successfully utilized in highly controlled manufacturing environments and in large retail environments to provide inventory tracking systems.

Another class of theft deterrence is detecting and controlling inventory shrinkage due to employee theft. This is a particularly acute problem in an environment having less control by nature than a retail merchandise store, such an environment being a restaurant or an establishment serving alcoholic beverages. It is not uncommon to encounter a 3% or greater shrinkage of revenue in restaurants or other establishments serving alcoholic beverages such as wine, liquor and beer. The shrinkage of revenue greatly impacts the profit margins and generally creates a difficult employee control situation. One of the issues in that environment is the inherent need for movement of items from stock rooms to bar areas during periods of greatest customer activity. Surveillance of staff and inventory is most difficult at this time of increased customer business. Another situation of interest is when there is no customer activity and a limited number of management staff is on the premises, perhaps before or after hours. Furthermore, employees may hide alcoholic drinks that they are consuming on the premises, so that the stolen property does not get removed from the premises and therefore cannot benefit from the typical retail RFID tag tracking methods.

There is a demand then for a solution to inventory tracking and control in relation to theft deterrence for retail establishments such as restaurants and bars.

In a related application of RFID technology, RFID tags can be deployed in credit cards and in fact planted in many devices that people carry with them so that the location and activity of people may be tracked by the careful deployment of RFID readers. For example, it is of interest for security and for marketing purposes to track people's locations in large events such as conferences, athletic venues or training events. Pertinent to the theft deterrence problem is that RFID tags may be placed in employee badges or uniforms so that employee locations and activities may be monitored.

What is needed in the less controlled environment of a restaurant or an establishment serving alcoholic beverages is a system that tracks both inventory and personnel and strongly correlates the inventory to the personnel during movement of inventory.

While RFID tags and readers have been deployed to track inventory in a large variety of situations, the art of systems that track both personnel and inventory simultaneously is not so well developed.

U.S. Patent Application No. 2006/0187042 discloses an RFID alarm investigation system that includes detecting an activated electronic article surveillance (EAS) tag in an interrogation zone, and reading at least one RFID tag in response to investigate the cause of the activated EAS tag. The invention relates specifically to typical retail store situations wherein a plurality of point of sale stations are situated in front of store exit and wherein the activated surveillance takes place near the exit door. A method for inventory tracking or personnel tracking is not included therein.

U.S. Pat. No. 7,012,528 to Matthewson, II et al. discloses information preparing a method for use in a retail environment by storing unique correlator values in RFID tags affixed to each item presented for purchase in a point of sale transaction. The purchaser is correlated to the items at the time of the sale. The method utilizes the printing of sales receipts with RFID tags and assumes a typical retail store environment wherein scanners are placed at every exit and there is a high degree of control. Matthewson does not disclose an inventory tracking system or a personnel tracking system.

Somewhat closer related is U.S. Patent Application No. 2006/0072787 which discloses an inventory control computer associating a tag with a transaction authorizing items to be removed from a location and having RFID readers. The readers transmit the RFID tag locations by time, sending alarms and notifications as required. A restaurant application is suggested but the method is more appropriately applied to a traditional retail store environment and does not address the need for or methods for personnel tracking in relation to inventory.

U.S. Patent Application No. 2006/0132311 describes the placement of RFID on liquor bottles for associating identification tags with an identifier in each item, teaching the use of readers in conjunction with the tags. However, there is no disclosure of an inventory tracking method or the combination therewith of a personnel tracking method.

U.S. Patent Application No. 2006/0015408 discloses a personnel activity tracking method in a retail store location by detecting the presence and absence of a merchandise servicer's RFID tag and transmitting detected result to a central location. Although a method for tracking personnel in the attendance of training events is disclosed, tracking personnel in relation to inventory management or theft deterrence is not described therein.

A tool tracking subsystem implemented by affixing RFID tags to both tools and personnel associating the tagged items with the person responsible for the item or responsible for the location of the item is disclosed in U.S. Patent Application No. 2007/0018826. While a computer network is disclosed to create a command and control environment, the methods for event correlation including the correlation of tools to personnel and an interrelated system of inventory management is not taught.

Generally, a need exists for a system and method to track inventory using RFID tags and readers wherein inventory is assigned to a person and systematically tracked by person until such time that the inventory is no longer held by the person.

### SUMMARY OF INVENTION

The present invention is a theft deterrence system for a business establishment selling alcoholic beverages. The business establishment has a physical premises with entry and exit doors to the outside. The premises include stock room locations with lockable doors for stocking beverage inventory, bar area locations having entry and exit points for selling beverages from beverage inventory, a holding area location for staging beverage inventory prior to placement in the stock room locations, and employees to sell beverages and to transfer beverage inventory from one location to another location.

The system comprises a set of RFID tagging devices physically attached to the beverage inventory. Each RFID tagging device contains a unique identifier, such as a SKU number, for each beverage type in the beverage inventory. A set of RFID readers are integrated with the shelves in the stock rooms and bar area locations so that RFID tagging devices are read if the RFID tagging devices are inside the stock rooms or bar areas. A computer system and network connects the sets of RFID readers and a set of point-of-sale (POS) devices. The computer system has an inventory database for storing, querying, and retrieving inventory data. A software program for tracking inventory operates on the computer system. The inventory is tracked by the software program by monitoring messaged data sent from the sets of RFID readers and the POS devices.

In an alternate embodiment, the system associates an employee to an inventory item using a set of RFID tagging devices attached to the person of each employee. Each employee has a unique identifier stored in the RFID tagging device. RFID readers are placed near the doors to the lockable stock room and placed in proximity to the bar area locations. In this embodiment, employees are associated with tagged inventory when the inventory is removed from the RFID reader enabled shelves.

In another alternate embodiment, each employee carries a smart card encoded with employee identification and function based credentials. Smart card readers are attached to the doors of the stock rooms and at the entrances of the bar locations. The smart cards are required to unlock the doors to the stock rooms.

The software program for tracking inventory is further comprised of programmed executable code. The programmed executable code interprets the messaged data and affects changes to the inventory database. In an alternate embodiment, the programmed executable code correlates at least one employee to at least one beverage type identifier from the set of RFID tagging devices.

The computer system further comprises a display means and a report generating means for displaying reports relating the transfer of inventory from one location to another location.

The messaged data contains at least a location, a time, a plurality of RFID unique identifiers, and a text field. Furthermore, the messaged data may include together at least one beverage inventory unique identifier from the set of RFID tagging devices and at least one employee unique identifier so as to correlate the employee identifier to the inventory identifiers.

The messaged data may contain inherent alarm conditions which upon reception by the computer system generate an alert which is communicated to other personnel on the premises. In an alarm condition, alarms are contained in messaged data and serviced by the computer system displaying them on a suitable screen or by creating email messages or cell phone text messages. Upon an alert condition, a continuously monitoring video surveillance system will capture the previous ten minutes of video in the area creating the alarm and send the video file to management.

The system may further comprise an additional set of RFID readers placed in proximity to bar area locations so that RFID tagging devices are read if the RFID tagging devices are outside the bar area locations and within a range of 0 to 15 feet from the bar area location entry and exit points. This feature of the invention allows for positive identification of items leaving a bar area location versus items having been left in a bar area.

The system maintains an inventory database made up of numerous tables. The tables include a set of stock room inventory tables containing records of stock room inventory transactions. The database inventory may further include a set of employee inventory tables where each employee inventory table contains records describing beverage inventory held by an employee while being transferred from one location to another. Additional tables include a set of bar inventory tables, a holding area inventory table with records of holding room inventory transactions, a sold inventory table containing records of beverage inventory purchased from the business establishment through a POS device, and a missing inventory table containing records of beverage inventory not accounted for in the other inventory tables of the inventory database. The inventory database may be queried by SQL commands.

A series of reports may be generated by the computer system. The software for reports displays a report view containing a set of records wherein contiguous events are reported. A list of items sold at the POS device is reported by item identifier, point of sale position, and item count. A set of records sorted by employee identifier, a set of records sorted by location, a set of records describing missing inventory, a set of records describing the quantity of items in stocked inventory, and a set of records describing reorder requirements for inventory can all be displayed as reports. Reorder requirements are the number of items required to be reordered so that stocked inventory is sufficient to meet sales demand.

The system is described in terms of state machines including enumeration of employee states and transitions, stock room states and transitions, bar area states and transitions and point of sale states and transitions in relation to the bar areas.

### BRIEF DESCRIPTION OF DRAWINGS

The disclosed inventions will be described with reference to the accompanying drawings, which show important sample embodiments of the invention and which are incorporated in the specification hereof by reference, wherein:

FIG. 1 is a schematic diagram of the flow of beverage inventory through a restaurant.

FIG. 2 is drawing of the inventory showing the placement of RFID tagging devices.

FIG. 3 is a use case diagram of the system for inventory tracking of the present invention.

FIG. 4 is a block diagram of an inventory rack RFID system including a transceiver enables storage system.

FIG. 5 is a block diagram of the system data structure of the RFID tracking system.

FIG. 6 is a flowchart diagram of the theft deterrence process where employees carry smart cards or RFID tagged badges of the present invention.

FIG. 7 is a flowchart diagram of the stock room sign in and sign out method where employees carry smart cards or RFID tagged badges of the present invention.

FIG. 8 is a flowchart diagram of the check out process for inventory of the present invention.

FIG. 9 is a flowchart diagram of the CHECKED OUT event servicing method where employees carry smart cards or RFID tagged badges of the present invention.

FIG. 10 is a flowchart diagram of the check in process for inventory of the present invention.

FIG. 11 is a flowchart diagram of the bar area inventory management method where employees carry smart cards or RFID tagged badges of the present invention.

FIG. 12 is a flowchart diagram of a method to track and time out inventory that is checked out.

FIGS. 13A and 13B are a flowchart diagram of a bar area service management process where employees carry smart cards or RFID tagged badges of the present invention.

FIG. 14 is a flowchart diagram of the “end of shift” inventory reconciliation process where employees carry smart cards or RFID tagged badges of the present invention.

FIG. 15 is a flowchart diagram of the theft deterrence process of the present invention.

FIG. 16 is a flowchart diagram of a method to track elapsed time of checked out inventory.

FIG. 17 is a flowchart diagram of a bar area service management process of the present invention.

FIG. 18 is a report view of an inventory movement report in the preferred embodiment of the present invention.

FIG. 19 is a report view of a POS activity report in the preferred embodiment of the present invention.

FIG. 20 is a drawing of three report views, an employee report view, a location report view and a missing inventory report view in the preferred embodiment of the present invention.

FIG. 21 is a report view of an inventory report in the preferred embodiment of the present invention.

FIG. 22 is a report view of a re-order report in the preferred embodiment of the present invention.

### DETAILED DESCRIPTION OF PREFERRED EMBODIMENTS

The numerous innovative teachings of the present application will be described with particular reference to the presently preferred embodiments (by way of example, and not of limitation).

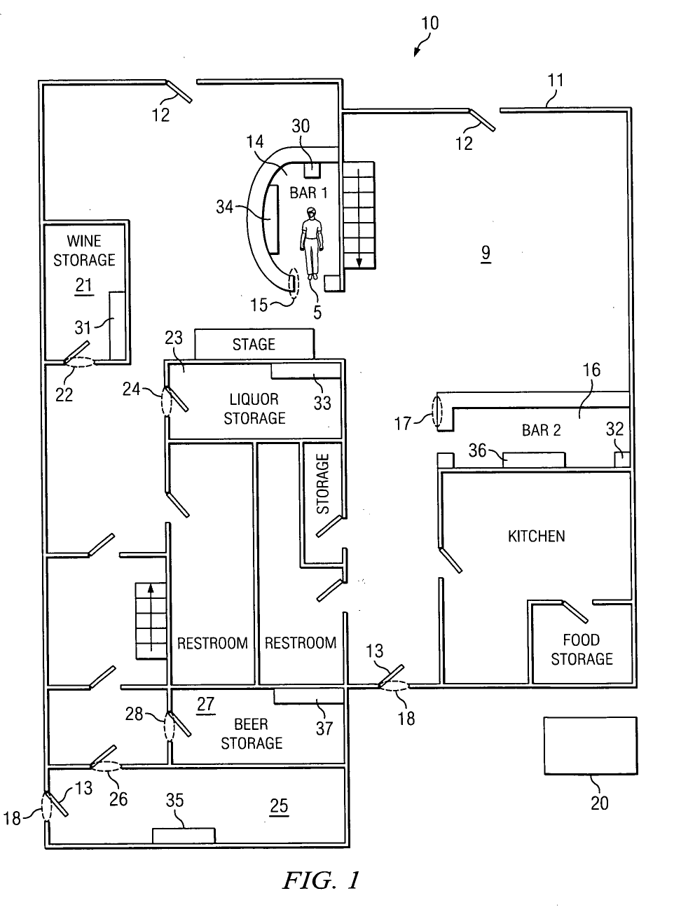

The present invention teaches a system and method for tracking inventory and enabling theft deterrence. The system and method deters employees, customers, or others from the theft of alcoholic beverage containers and similar inventory items in a restaurant or similar environment. FIG. 1 shows a typical situation wherein premises 10 is a building defined by outer walls 11, front external doors 12, and rear external doors 13. Premises 10 has three stock room areas: wine stock room 21 for storing wine inventory, liquor stock room 23 for storing liquor inventory, and beer stock room 27 for storing beer inventory. Premises 10 further includes two bar areas for selling drinks, first bar area 14 and second bar area 16. First bar area 14 has at least one point of sale machine, POS 30 and second bar area 16 has at least one point of sale machine, POS 32. Additionally, premises 10 has a holding area 25 for receiving inventory from outside sources and for staging inventory before transfer to one of the three stock room areas 21, 23 and 27. The remainder of premises 10 will be defined as the floor 9 on which employees and customers move about freely. In particular, employee 5 may transfer inventory from a stock room such as beer stock room 27 to a bar area such as first bar area 14 by walking the inventory across floor 9. Other employees (not shown) may work in the bar area utilizing POS 30 and POS 32 to affect the sale of inventory to customers. A set of video surveillance cameras networked to the computer system 20 continuously monitor the premises including the stock room areas and the bar areas.

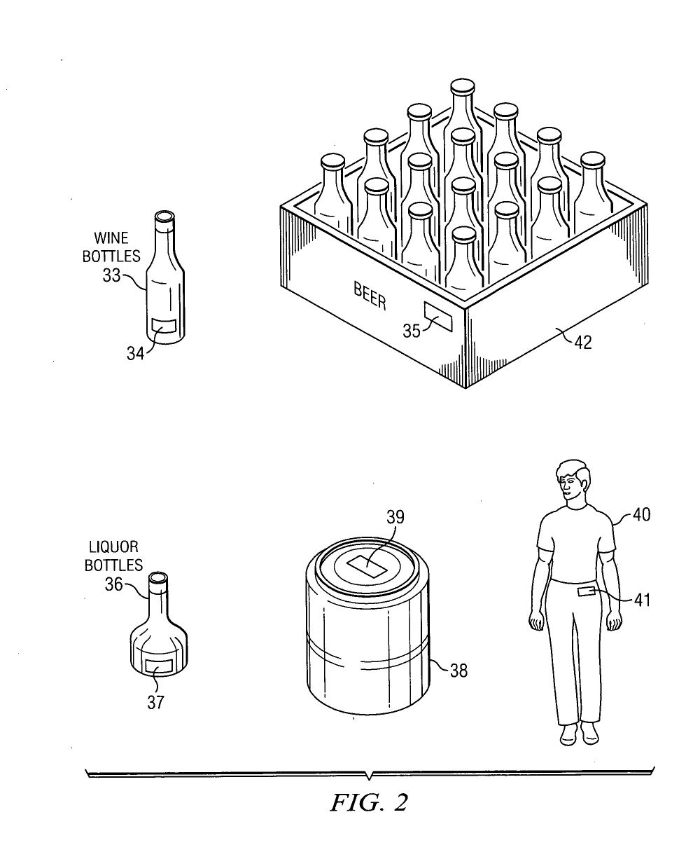

In an alternate embodiment, a set of smart card scanners are deployed in premises 10. Smart card scanners are linked to the locks of specific doors. A smart card with appropriate clearance must be used to unlock and pass through these specific doors. As depicted in FIG. 2, an employee 40 carries a smart card 41 which can be integrated into the employee's ID badge. The smart cards are encoded with employee identification information and access credentials. Once an employee enters an area using the smart card, that employee may be associated with the inventory in that area. Stock room smart card scanner 22 is fixed at the door of wine stock room 21 so as to identify employees which enter and exit. Stock room smart card scanner 24 is similarly fixed at the door of liquor stock room 23; stock room smart card scanner 28 is similarly fixed at the door of beer stock room 27. Holding room smart card scanner 26 is fixed at the interior door of holding area 25. Smart card scanners 18 are placed at rear external doors 13 to control access to the rear of the establishment. First bar area 14 has smart card scanner 15 fixed near the entrance to first bar area 14. Smart card scanner 17 is fixed near the entrance to second bar area 16. In an alternate embodiment, smart card scanner 15 is integrated with POS 30 and smart card scanner 17 is integrated with POS 32.

In another alternate embodiment, each employee's identification badge includes an RFID tag. In this embodiment, RFID readers are affixed at the doors of the stock room areas and the bar areas instead of smart card readers. An employee may be associated with the inventory in an area when the RFID reader of that area detects the employee's presence.

Inventory is shelved on racks inside stock rooms 21, 23, and 27; bar areas 14 and 16; and holding area 25. Rack 31 is located in stock room 21, rack 33 is positioned in stock room 23, and rack 37 is resident in stock room 27. Rack 34 is located in first bar area 14, rack 35 is positioned in holding area 25, and rack 36 is in second bar area 16. The racks are transceiver enabled storage units (TESU) and are each equipped with at least one RFID reader. Each TESU reader has an integrated wireless LAN transmitter and receiver so as to have the capability to report localized RFID tags attached to the inventory. All TESUs and RFID readers and smart card scanners (if present) report to a central computer system 20 for logging reader events and alarms and for maintaining an inventory database. In an alternate embodiment, racks 34 and 35 in the bar areas may be replaced with an RFID patch antenna located in each bar area. The RFID patch antennas are continuously enabled and can generate inventory check in events when an RFID tagged inventory is detected in the bar area.

FIG. 2 is a drawing indicating how the RFID tagging devices may be attached to inventory and how smart cards or RFID tagged identification badges are carried by employees. Each wine container 33 has an RFID tagging device 34 attached thereto and each liquor container 36 has an RFID tagging device 37 attached thereto. Each case of beer 42 has RFID tagging device 35 attached thereto and each keg of beer 38 has RFID tagging device 39 attached thereto. RFID tags are placed on the inventory in such a way that removal of tags will destroy the tag's ability to transmit RFID signals. The RFID tagging devices may be attached to the inventory by means of a cable tie having an integrated RFID tag, an RFID tag attached to the side of the bottle with adhesive, or an RFID tag integrated into the bottle label. Various means of attachment may be conceived within alternate embodiments. Also, other inventory besides beverages may also have RFID tags attached. Tags can be applied individually by the receiving personnel at the restaurant/bar or pre-applied to bottles before delivery.

The passive RFID tags provide a unique identifier for each bottle and container. The passive RFID tags may hold information regarding the origin and contents of the bottle, such as the distributor and the brand of liquor and may be writeable so as to include the inventory SKU number. The information held on each RFID tag may be read out by an RFID reader device as known in the art. Passive RFID tags may be made available in pre-labeled rolls corresponding to specific labels and then the labels are applied to bottles during inventory staging. Examples of pre-labeled rolls are Finlandia Vodka 1 L and Lagavullin 8 year 1 L. Bottle content, origin information, and the inventory SKU numbers may also be held in an inventory database provided by the distributor or alternatively created as a result of the purchasing process or alternatively derived from the distributor manifest by a lookup process. Passive RFID tags may be pre-perforated or breakaway across at least one circuit component, rendering the tags useless for transmission if tag is applied and then later removed from the bottle surface.

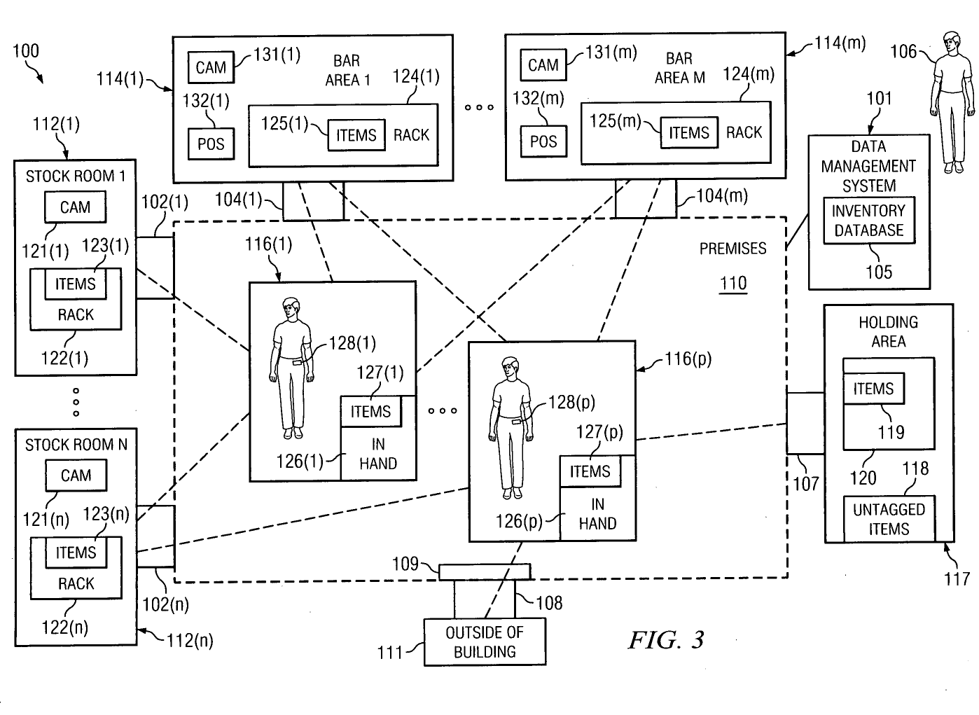

In FIG. 3, the system for theft deterrence 100 is defined in terms of a system diagram. Premises 110 on which the system is deployed has attached to it a set of stock rooms 112(1) . . . 112(n), a set of bar areas 114(1) . . . 114(m), and a holding area 117. Employees 116(1) . . . 116(p) and a data management system 101 are also contained on the premises 110. In an alternate embodiment, data management system 101 may be offsite. In an alternate embodiment, the system for theft deterrence 100 may include a set of smart card readers 102(1) . . . 102(n) attached to stock rooms 112(1) . . . 112(n), a set of smart card readers 104(1) . . . 104(m) attached to bar areas 114(1) . . . 114(m), a set of smart card readers 108 attached to external doors 109 leading to the outside of the building 111, and a smart card reader 107 attached to the door of holding area 117. In additional alternate embodiments, the smart card readers may be substituted for RFID readers. The system is further comprised of sets of RFID tagged items 123(1) . . . 123(n) on RFID enabled racks 122(1) . . . 122(n) in their respective stock rooms 112(1) . . . 112(n), sets of RFID tagged items 125(1) . . . 125(m) on RFID enabled racks 124(1) . . . 124(m) in respective bar areas 114(1) . . . 114(m), a set of RFID tagged items 119 in proximity to an RFID reader 120 in holding area 117, and a set of recently received and as of yet untagged items 118 in holding area 117. A set of employee identification badges 128(1) . . . 128(p) on the set of p employees 116(1) . . . 116(p), sets of RFID tags 127(1) . . . 127(p) on inventory 126(1) . . . 126(p) held by employees 116(1) . . . 116(p), and a data management system 101 to which all the sets of RFID enabled racks are communicatively connected by a computer network wherein the sets of RFID enabled racks communicate data pertaining to tagged inventory in close proximity. In alternate embodiments, the set of employee identification badges 128(1) . . . 128(p) may include RFID tags or smart cards containing employee identification information and access credentials.

Data management system 101 has a computer with memory, storage capability, and display monitor capability. The computer is programmed via software running on at least one central processing unit to operate an inventory data base 105 and may be monitored by an operations manager 106.

Additionally, the stock rooms have cameras 121(1) . . . 121(m) and bar areas have cameras 131(1) . . . 131(m) connected to the data management system to accomplish continuous surveillance. During error and alarm events, the system will capture the recent video of the stock room or bar area associated to the alarm event and save it. The video file will be for the most recent X minute period prior to the alarm or error. The value X is a system parameter configurable by the system administrator.

The bar areas also have point of sale (POS) devices 132(1) . . . 132(m) connected to the data management system for accumulating sales of drink items. The POS devices not only track the amount of beer bottles and wine bottles to be sold, but the POS devices 132(1) . . . 132(m) also track the consumption of liquor based on bar sales or the amount of pours from each bottle based on sales. The system compares the pour amounts based on sales with the amount of liquor checked into the bar in RFID tagged bottles. During the end of shift process, the POS data, bottles remaining, empty bottle count, and broken bottle count is reconciled. Discrepancies can be caused by over-pouring or under-pouring by bartenders, unauthorized pouring not related to sales, purchases unfulfilled (dropped drinks), inaccurate recipes in the POS system, or theft of inventory.

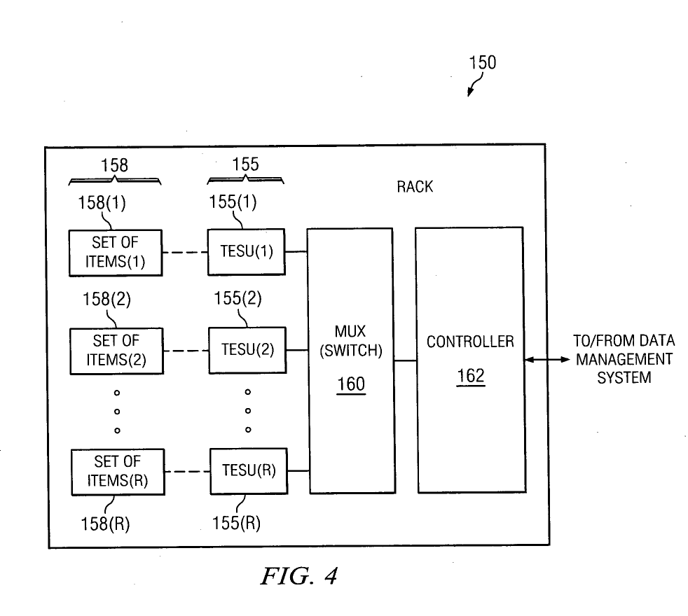

FIG. 4 is a block diagram showing the RFID enabled rack system 150 which is comprised of a set of transceiver-enabled storage units (TESU) 155(1) . . . 155(R). Each TESU has an RFID transceiver for querying RFID tags on the respective proximate set of items and is capable of holding at least one drink container or RFID tagged item. In some embodiments the TESU may hold up to fifty drink containers and query fifty RFID tags at a time. Each TESU is communicatively connected to mux switch 160 which is further communicatively connected to controller 162. Mux switch 160 operatively connects each TESU sequentially to controller 162. Inventory or a set of items 158(1) . . . 158(R) is stored or displayed on a set of TESU 155(1) . . . 155(R). Each TESU 155(1) . . . 155(R) is proximate to and in communications with the corresponding inventory or set of items 158(1) . . . 158(R) by radio frequency (RF) signal probe.

Controller 162 is a computer for controlling the operation of the set of TESUs and the mux switch and for communicating with data management system 101. Controller 162 checks each TESU data string for completeness, queries each TESU over a given interval of time, and sends the data to the data management system. Data management system 101 continuously updates and monitors the states of various objects in the system, logging object events for inventory bookkeeping and for alarming.

System for theft deterrence 100 includes a set of computer programs which operate interactively on the data management system computer and on the controllers. The set of computer programs may be written in one or more programming languages such as Java, C#, or C++ and reside in memory on the computer and controllers.

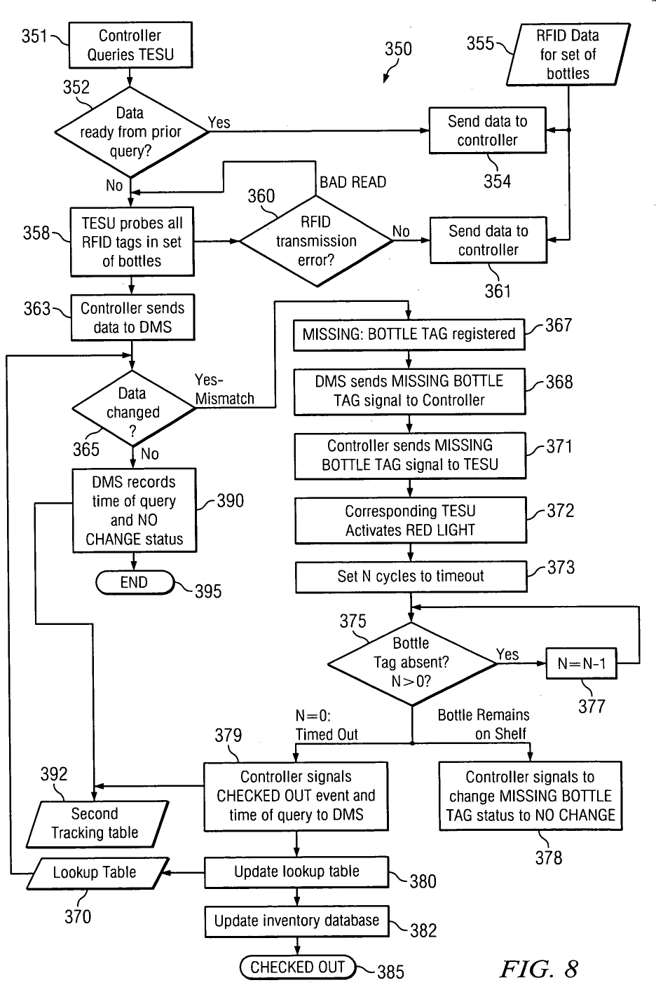

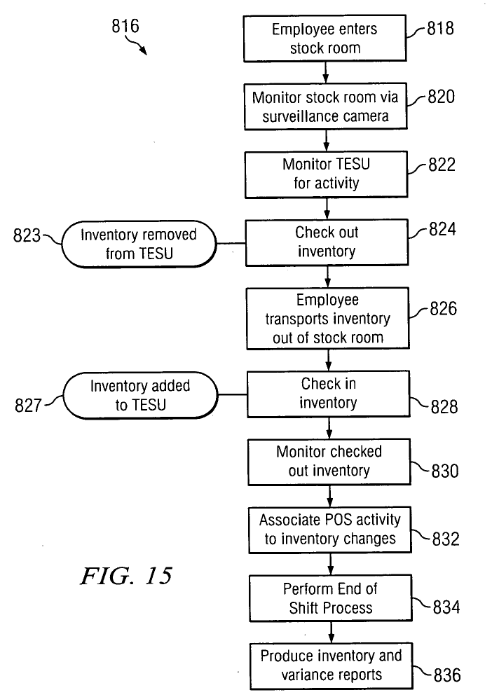

The preferred embodiment of theft deterrence 100 is shown in FIG. 15 as process for theft deterrence 816. An employee enters a stock room filled with RFID tagged inventory at step 818. At step 820, all the stock rooms, as well as the bar areas, are continuously monitored via a surveillance camera system capable of automatically saving and storing a predetermined duration of video upon an alert event. In step 822, the TESU rack systems are monitored for activity, such as removal or addition of inventory items, wherein each inventory item has an RFID tag attached to it. If an item is detected to have been removed from a TESU in step 823, then in step 824, the inventory item is updated to CHECKED OUT status by DMS 101. The monitoring process of step 822, in the event of item removal, is shown in FIG. 8.

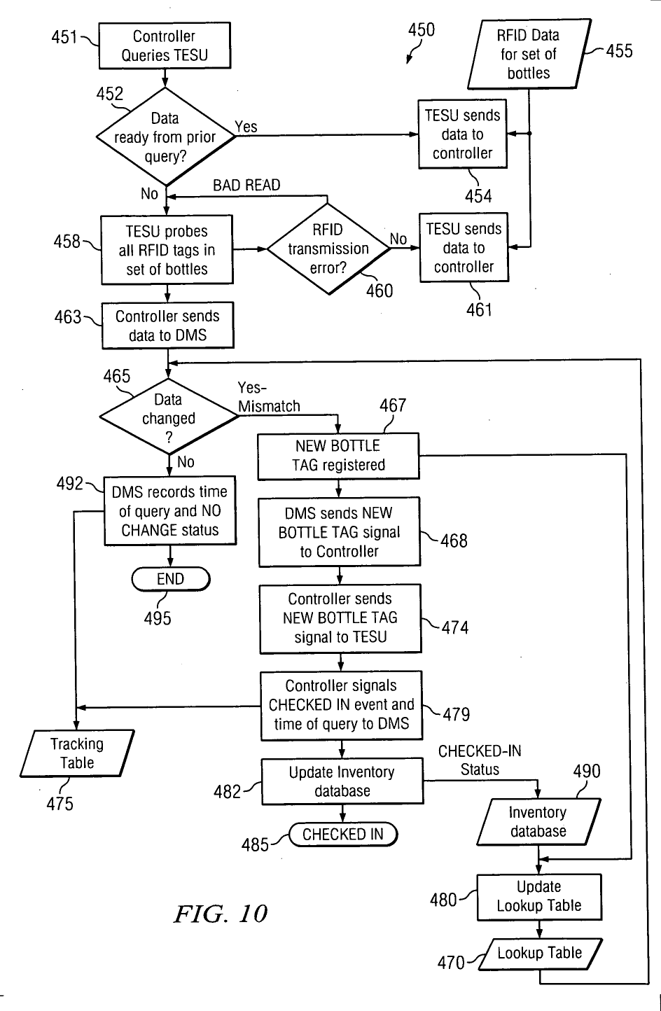

Inventory items are transported from the stock room to a bar area or another stock room by an employee in step 826. In step 827, a TESU may also detect that an inventory item has been added in which case the inventory item is updated to a CHECKED IN status in step 828. The monitoring process of step 822, in the event of item addition, is shown in FIG. 10.

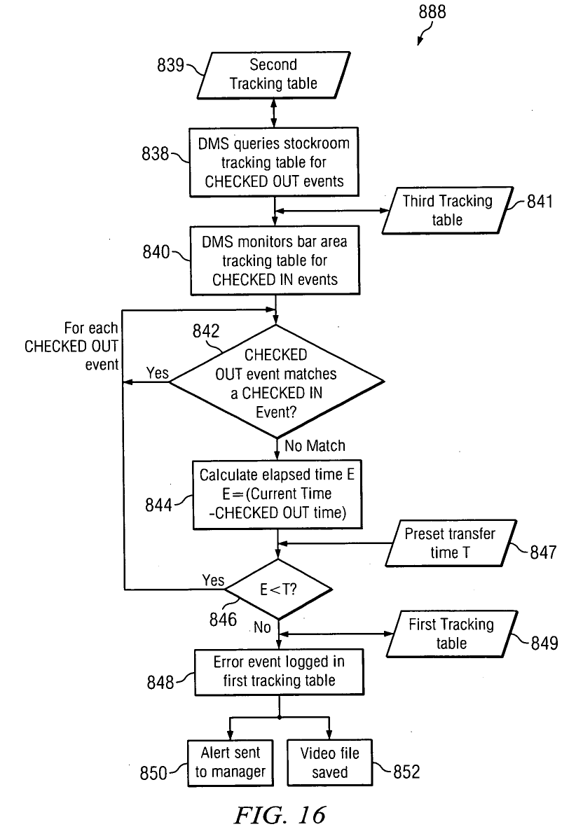

To alert managers to potential inventory theft, inventory items with checked out status are monitored in step 830 for timely check in. In the event of an alert condition wherein the time between CHECKED OUT and CHECKED IN events is greater than a predefined time, alert messages are accordingly sent to DMS 101 and the system will capture the video of the stock room or bar area associated to the alarm event and save it. The video file will be for the most recent X minute period prior to the alarm or error. The step 830 of monitoring checked out inventory is described in more detail in the discussion of FIG. 16.

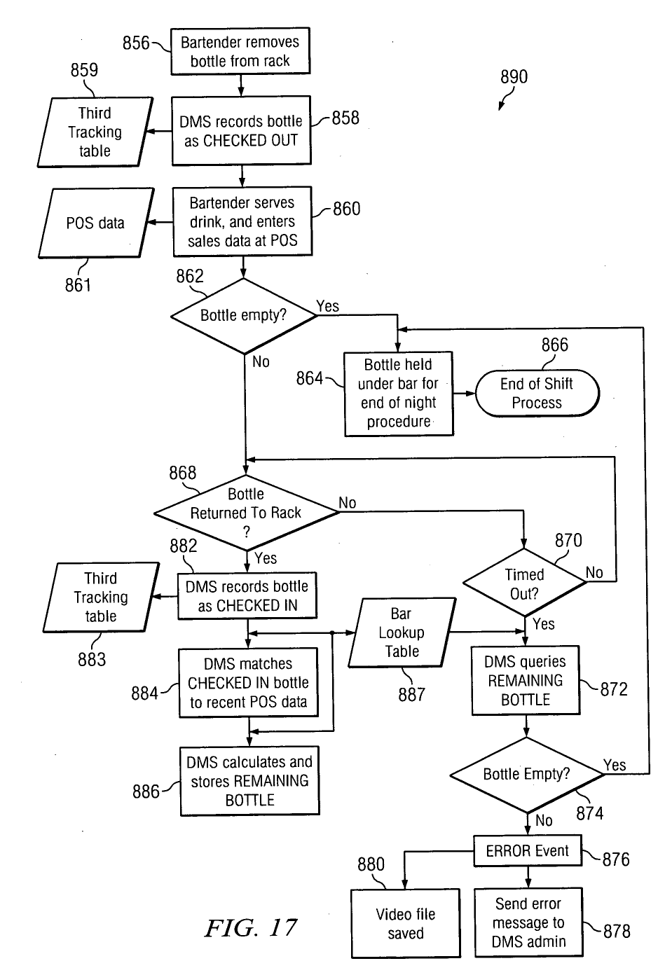

In the case of a bar, inventory may be sold to customers in the forms of shots of liquor from a given bottle which is a single inventory item. It is necessary to track the amount of liquor remaining in all bottles of inventory at all times to detect theft situations. To detect the amount of liquor remaining in a given bottle, the inventory item number of the bottle is associated to sales activity at the point-of-sale device in the bar area in step 832. The percentage of liquor remaining is then updated by DMS 101. The association of POS transactions to inventory levels of step 832 is shown in FIG. 17.

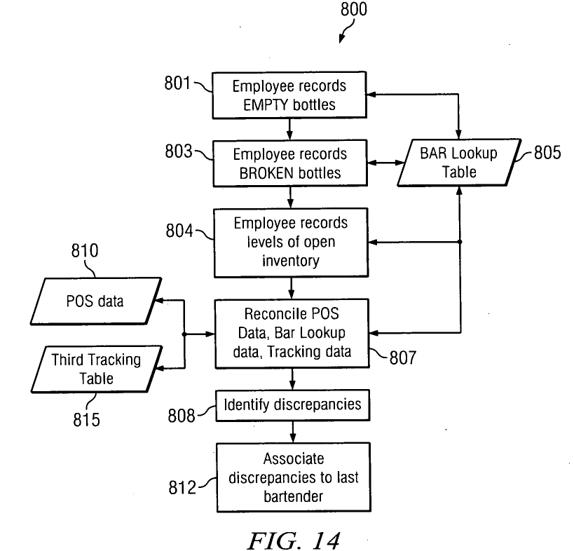

End of shift process, step 834 provides for further detection of theft activity. An employee recognizes the empty bottles, broken bottles, and remaining levels of open inventory and manually enters the data into the POS system. If discrepancies are determined between the manually entered data and the POS data, variance reports are generated. FIG. 14 shows the end of shift process of step 834.

With the associations made in step 832 and potentially stolen inventory items being identified in step 834, step 836 produces a set of inventory and variance reports.

Process 888 of monitoring CHECKED OUT inventory is shown as a flow chart in FIG. 16. As CHECKED OUT inventory leaves stockroom, a timer is started and continues until that inventory is CHECKED IN at another location on the premises. If the time elapsed between CHECKED OUT and CHECKED IN events is greater than a predetermined time period, an alert condition is marked and a video file of the area the item was CHECKED OUT of is captured and saved. Process 888 is run continuously as a background process in the DMS computer. In step 838, the DMS queries the stock room tracking table and second tracking table 839 for CHECKED OUT events. In step 840, the DMS monitors the bar area tracking table and third tracking table 841 for CHECKED IN events.

In step 842, an attempt is made by the DMS to match a CHECKED OUT event to a CHECKED IN event. If a match is found, step 842 is performed for another CHECKED OUT event. If no match is found, then the elapsed time E is computed in step 844 as the difference between the current time and the CHECKED OUT event time recorded in the tracking table. In step 846, the elapsed time E is compared to a preset transfer time T 847. If elapsed time E is less than T, then step 842 is repeated for another CHECKED OUT event. If elapsed time E is greater than or equal to T, then in step 848, an error event is logged in first tracking table 849. At step 850, an alert may be generated and sent to a manager on duty for example to a specified pager device phone number or email address so that the manager may know to take rectifying action. At step 852, a video file of the area of the alert is saved. The duration of the video file is X minutes prior to the alert condition. The value X is a system parameter configurable by the system administrator.

FIG. 17 is a flowchart of a bar service management process 890 where POS activity is associated to levels of inventory. After accepting an order from a customer, the bartender removes a bottle from the rack in step 856. This action causes the DMS to record the bottle with a given bottle ID as CHECKED OUT, the event being recorded in third tracking table 859. The bartender then mixes and serves the drink and the sales data is entered at the POS in step 860. The POS event is recorded in POS data 861. If the bottle is empty, then in step 862, the bartender places the empty bottle including its bottle RFID tag under the bar in step 864 for an end of shift process 866. If the bottle is not empty, the bottle should be returned to the rack after the drink has been made. This may be done immediately after the POS transaction or some time thereafter according to the work load of the bartender. Step 868 queries whether the bottle has been returned to the rack. Steps 868 and 870 perform a timed out process to capture situations where bottles may not have been returned or in fact may have been taken out of the bar in an unauthorized way. If the bottle is not returned to the rack after a preset time period checked by step 870, then in step 872 the DMS queries the bar lookup table 847 for the REMAINING BOTTLE attribute of the given bottle ID. The result of step 872 is checked in step 874 to determine if the bottle is empty. If empty, it is assumed that the bottle has been held under the bar in step 864. If the bottle is not empty, an ERROR event is initiated in step 876 followed by sending a message to the DMS administrator in step 878 and a video file is captured and saved in step 880.

After the bottle is returned to the rack, in step 882, the DMS records the bottle as CHECKED IN. The event is recorded in third tracking table 883. In step 884, the DMS matches the CHECKED IN bottle ID to recent POS data by querying the bar lookup table 887 and POS data 861. POS data 861 includes the amount of liquor used in mixing the drink, so in step 886 the DMS calculates and stores the amount of liquor remaining in the bottle as REMAINING BOTTLE attribute in bar lookup table 887.

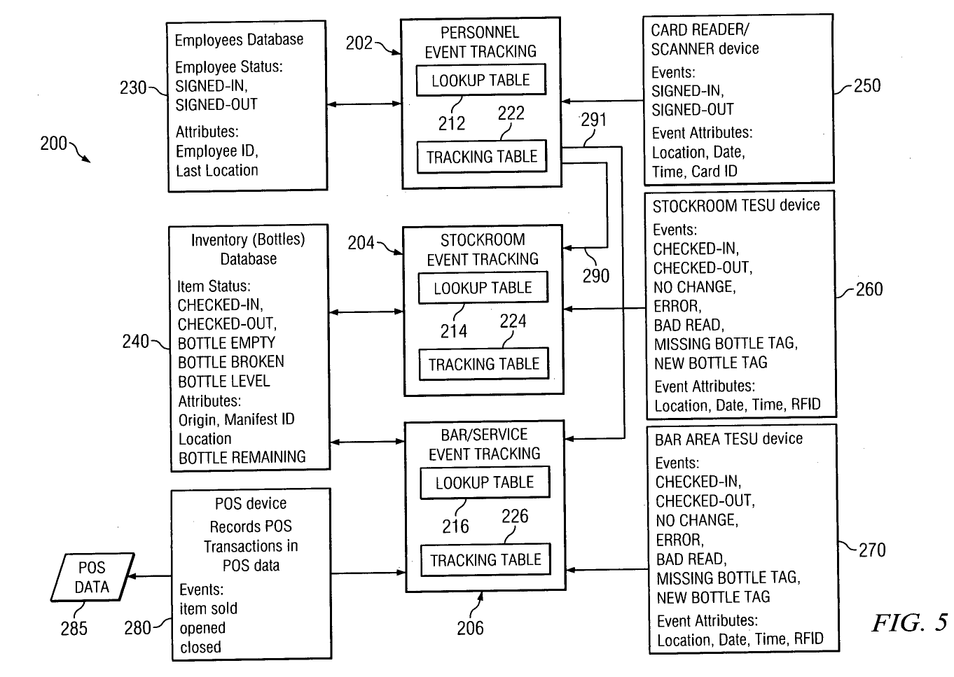

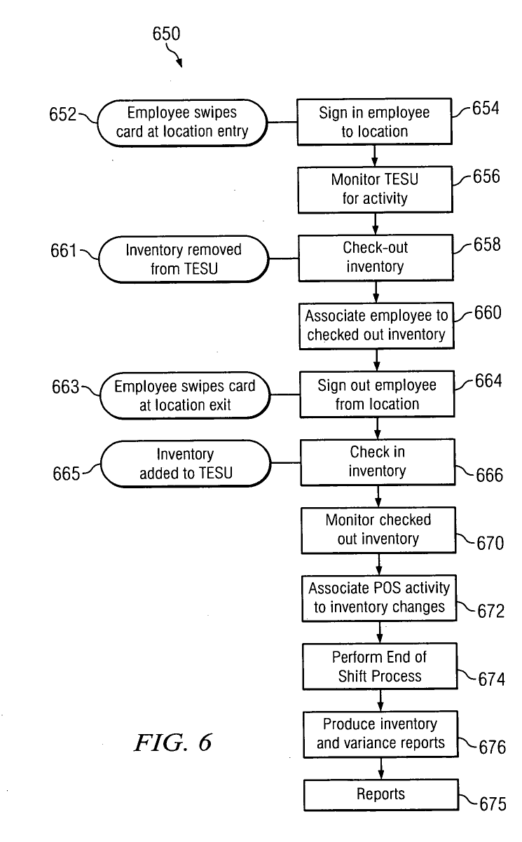

FIG. 5 shows an alternate embodiment of theft deterrence 100 where employees carry a smart card or an RFID tagged badge and the stock room doors and bar area entrances include smart card or RFID readers. In FIG. 5, a block diagram is shown to indicate operative function 200 of the set of computer programs. FIGS. 6 through 14 show the methods that implement operative function 200 using smart card or RFID tagged employees. Alternatively, in the preferred embodiment, system for theft deterrence 100 does not incorporate the use of smart cards, smart card readers, or RFID tagged employees and therefore the inventory is associated to the employee via a continuously monitoring video surveillance system rather than an employee database and personnel event tracking table.

As shown in FIG. 5, operative function 200 comprises event tracking programs including personnel event tracking 202, stock room event tracking 204, and bar event tracking 206. Operative function 200 also includes databases implemented on a database engine running on the database management system. The databases include employee database 230 for holding employee data and inventory database 240 for holding drink bottle/container data. Operative function 200 further comprises a set of device programs for servicing events. The device programs include card reader/scanner program 250, stock room TESU program 260, bar area TESU program 270, and POS device program 280.

Employee database 230 is a relational database which holds employee records having at least the fields of employee ID, last location, and employee status. The employee status is comprised of at least the states of SIGNED-IN or SIGNED-OUT.

Inventory database 240 is a relational database which holds at least the fields of manifest ID, origin, location, BOTTLE REMAINING, and item status. The item status is at least comprised of the states CHECKED-IN, CHECKED-OUT, BOTTLE EMPTY, BOTTLE BROKEN, or BOTTLE LEVEL.

Card reader/device program 250 is a program implemented on the controller to which a physical card reader is attached. Card reader/device program 250 is capable of gathering information from a smart card or RFID tagged employee badge, validating it, and generating at least the events of SIGNED-IN, SIGNED-OUT, AVAILABLE and UNAVAILABLE. The SIGNED-IN and SIGNED-OUT events have a set of event attributes associated thereto including at least the location of the card reader or RFID reader, event date, event time, and card ID. A generated event will be reduced to a serial stream of ASCII data and communicated to the data management system 101. The SIGNED-IN event signals that a valid card or badge has been successfully swiped at an entry card reader or read by an RFID reader and the data associated to the card or badge exchanged with the data management system 101. The SIGNED-OUT event signals that a valid card or badge has been successfully swiped at an exit card reader or read by an RFID reader and the data associated to the card or badge exchanged with the data management system 101. The AVAILABLE event signals that the card reader or RFID reader is active and ready. The UNAVAILABLE event signals that the card reader or RFID reader is inactive. Card reader/scanner device program 250 may report at events or periodically to the data management system.

Stock room TESU device program 260 is a program implemented on the controller to which a set of TESUs and the data management system 101 are communicatively attached as in rack 150 in the preferred embodiment. Stock room TESU device program 260 generates at least the events of CHECKED-IN, CHECKED-OUT, NO CHANGE, ERROR, BAD READ, MISSING BOTTLE TAG, and NEW BOTTLE TAG. The events CHECKED IN, CHECKED OUT, MISSING BOTTLE TAG, and NEW BOTTLE TAG have associated with them at least the attributes of location, date, time, and RFID. Other events have at least the attributes of location, date, and time associated to them in addition to other descriptive information such as pertinent error codes. A CHECKED-IN event signals to data management system 101 that a previously stored bottle has been received into a TESU for storage. A CHECKED-OUT event signals to data management system 101 that a stored bottle has been removed from the TESU and has been validated by the data management system as described later in this specification. A NEW BOTTLE TAG event signals to the data management system that a bottle not previously stored in the system has been received into a TESU for storage. A MISSING BOTTLE TAG event signals to the data management system that a previously stored bottle tag is no longer available and has not yet been validated by the data management system. The other stock room TESU device events will be described further below in connection to the various methods of the present invention.

Bar area TESU device program 270 is a program implemented on the controller to which a set of TESUs and data management system 101 are communicatively attached as in rack 150 in the preferred embodiment. Bar area TESU device program 270 generates at least the events of CHECKED-IN, CHECKED-OUT, NO CHANGE, ERROR, BAD READ, MISSING BOTTLE TAG, and NEW BOTTLE TAG. The events CHECKED IN, CHECKED OUT, MISSING BOTTLE TAG, and NEW BOTTLE TAG have associated with them at least the attributes of location, date, time, and RFID. Other events have at least the attributes of location, date, and time associated to them in addition to other descriptive information such as pertinent error codes. A CHECKED-IN event signals to data management system 101 that a previously stored bottle has been received into a TESU for storage. A CHECKED-OUT event signals to data management system 101 that a stored bottle has been taken from the TESU and has been validated by the data management system as described later in this specification. A NEW BOTTLE TAG event signals to the data management system that a bottle not previously stored in the system has been received into a TESU for storage. A MISSING BOTTLE TAG event signals to the data management system that a previously stored bottle tag is no longer available and has not yet been validated by the data management system. The other bar area TESU device events will be described further below in connection to the various methods of the present invention.

Point of sale (POS) device program 280 records POS transactions in POS data 285 which is also implemented as a database. The recorded POS transactions will hereafter be described as POS data 285. Events captured in POS data 285 include transactions such as ITEM SOLD, POS opened, and POS closed. Typical attributes associated to the ITEM SOLD event are product SKU, date, time, quantity, unit price, and total price.

Personnel event tracking function 202 comprises first lookup table 212 and first tracking table 222. First look lookup table 212 associates SIGNED-IN and SIGNED-OUT events with an employee ID from employee database 230. First tracking table 222 maintains a record of card reader device generated events including at least SIGNED-IN, SIGNED-OUT events with dates, times, locations, and smart card ID.

Stock room event tracking function 204 comprises second lookup table 214 and second tracking table 224. Second look lookup table 214 maintains records of bottle RFID tags associated with TESUs in all stock rooms, including fields for at least the RFID tag ID, TESU identifier, and manifest ID. Second lookup table 214 may also have bottle attribute fields such as BOTTLE REMAINING and origin. Second tracking table 224 maintains a record of stock room TESU generated events including at least CHECKED-IN, CHECKED-OUT and NO CHANGE events with dates, times, locations, and RFID tag ID.

Bar area event tracking function 206 comprises third lookup table 216 and third tracking table 226. Third look lookup table 216 maintains records of bottle RFID tags associated with TESUs in all bar areas, including fields for at least the RFID tag ID, TESU identifier, and manifest ID. Third lookup table 216 may also have bottle attribute fields such as BOTTLE REMAINING and origin. Third tracking table 226 maintains a record of bar area TESU generated events including at least CHECKED-IN, CHECKED-OUT and NO CHANGE events with dates, times, locations, and RFID tag ID.

When items of inventory are moved from one location to another, the items are associated with the employee who used a smart card to gain access to the stock room to pick up the items. Associations are made by the data management system between employees and RFID tagged inventory. Association 290 identifies inventory in stock room event tracking 204 that has been CHECKED OUT and assigns that inventory to a SIGNED IN employee in personnel event tracking 202. Similarly, association 291 identifies inventory in bar event tracking 206 that has been CHECKED OUT and assigns that inventory to a SIGNED IN employee in personnel tracking 202.

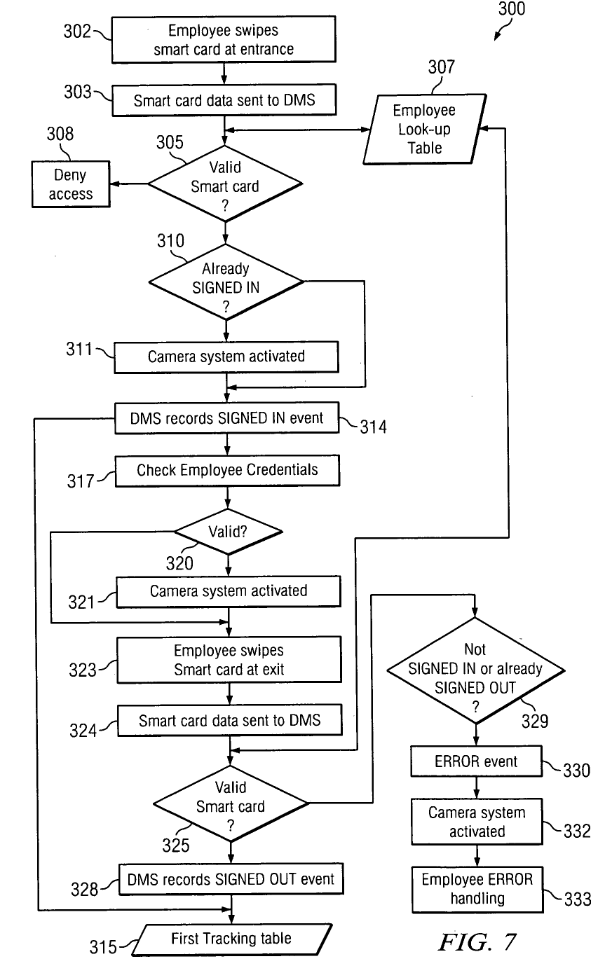

An alternate embodiment of the system for inventory tracking and theft deterrence is process for theft deterrence 650 shown in FIG. 6. When an employee swipes a smart card into the card scanner at the entry to a location in step 652, the employee is updated by DMS 101, in step 654, to SIGNED IN status at that location. Similarly, when an employee swipes a smart card into the card scanner at an exit to a location in step 663, the employee is updated to SIGNED OUT status at that location in step 664. The sign-in and sign-out processes of steps 654 and 664 are described in more detail in relation to FIG. 7.

In step 656, the TESU rack systems are monitored for activity, such as removal or addition of inventory items, wherein each inventory item has an RFID tag attached to it. If an item is detected to have been removed from a TESU in step 661, then in step 658, the inventory item is updated to CHECKED OUT status by DMS 101. The monitoring process of step 656, in the event of item removal, is shown in FIG. 8.

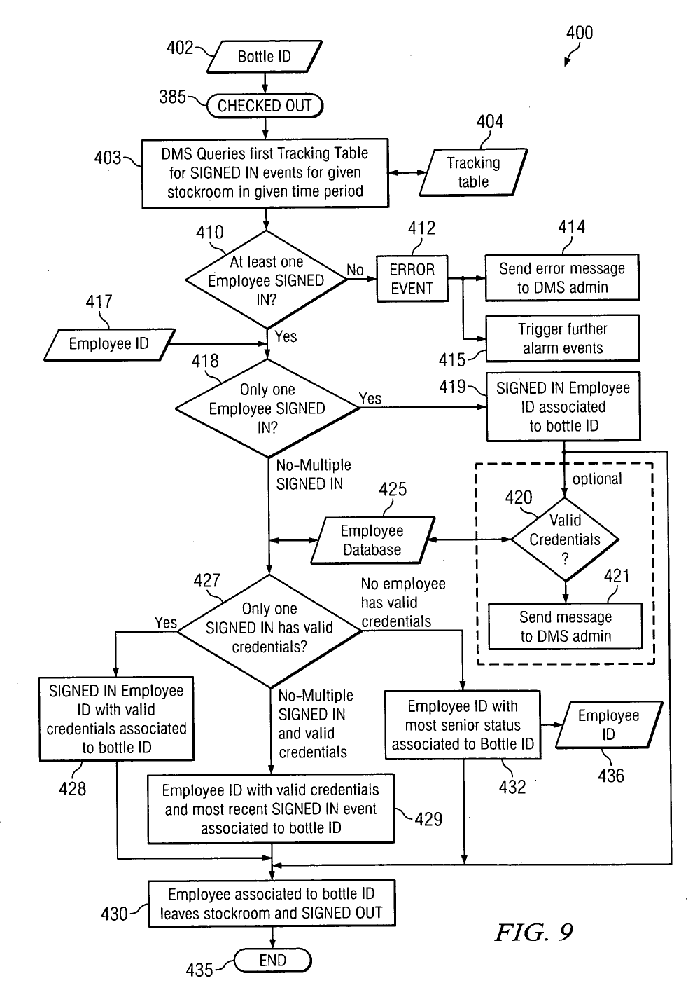

Inventory and employees are associated in step 660. Each removed inventory item with CHECKED OUT status is associated to an employee with SIGNED IN status. The association process of step 660 for checked out items is shown in FIG. 9.

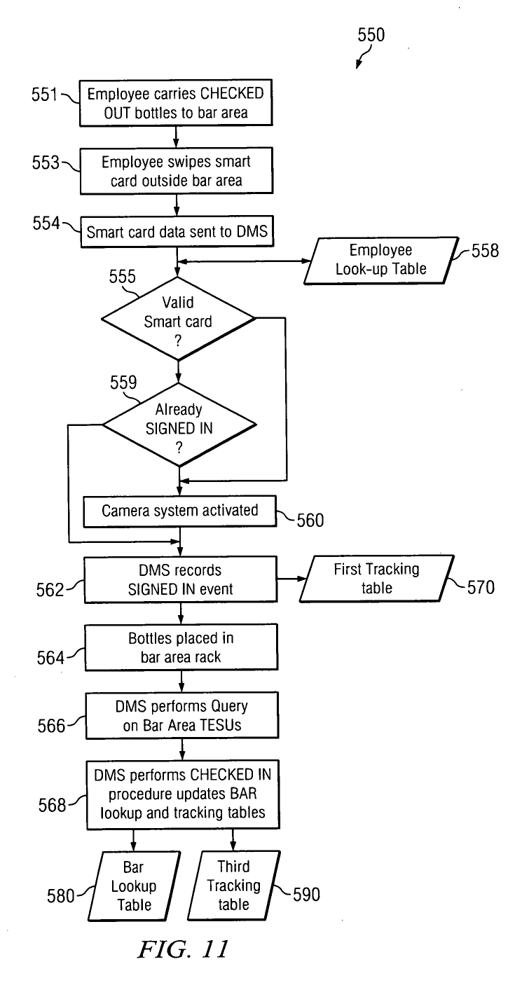

In step 665, a TESU may also detect that an inventory item has been added in which case the inventory item is updated to a CHECKED IN status in step 666. The monitoring process of step 656, in the event of item addition, is shown in FIG. 10. The check in process of step 666 and employee sign in process at a bar area is shown in FIG. 11.

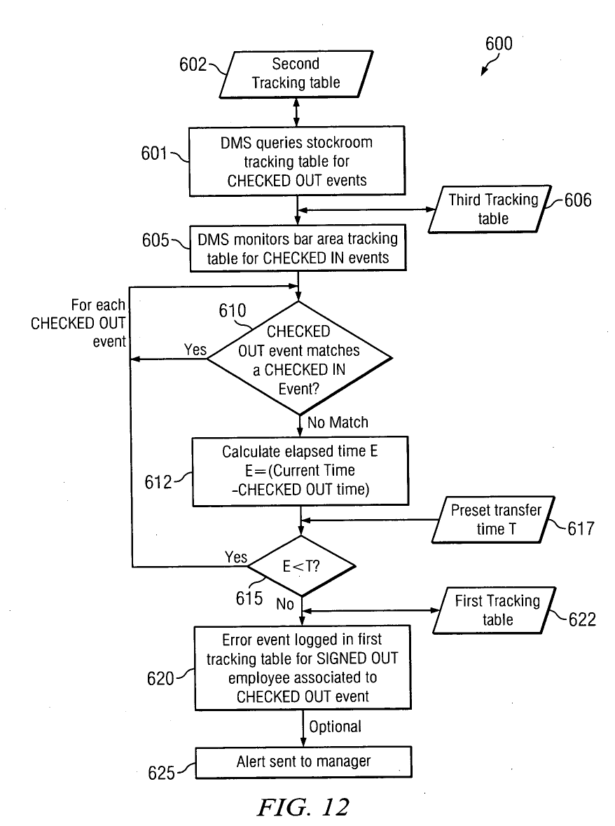

To alert managers to potential inventory theft, inventory items with checked out status are monitored in step 670 for timely check in. In the event of an alert condition wherein the time between CHECKED OUT and CHECKED IN events is greater than a predefined time, alert messages are accordingly sent to DMS 101. The step 670 of monitoring checked out inventory is described in more detail in the discussion of FIG. 12 below.

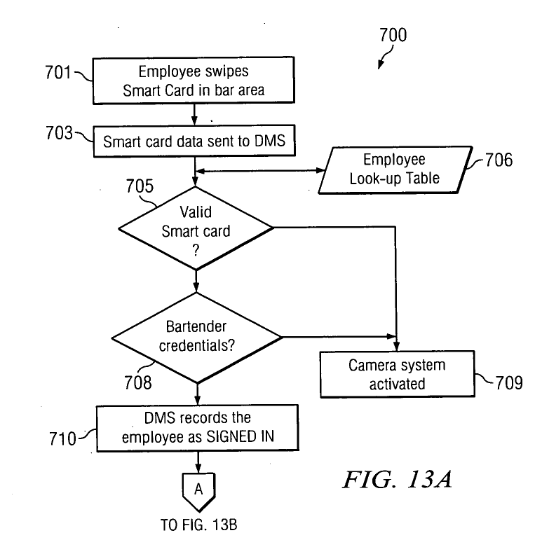

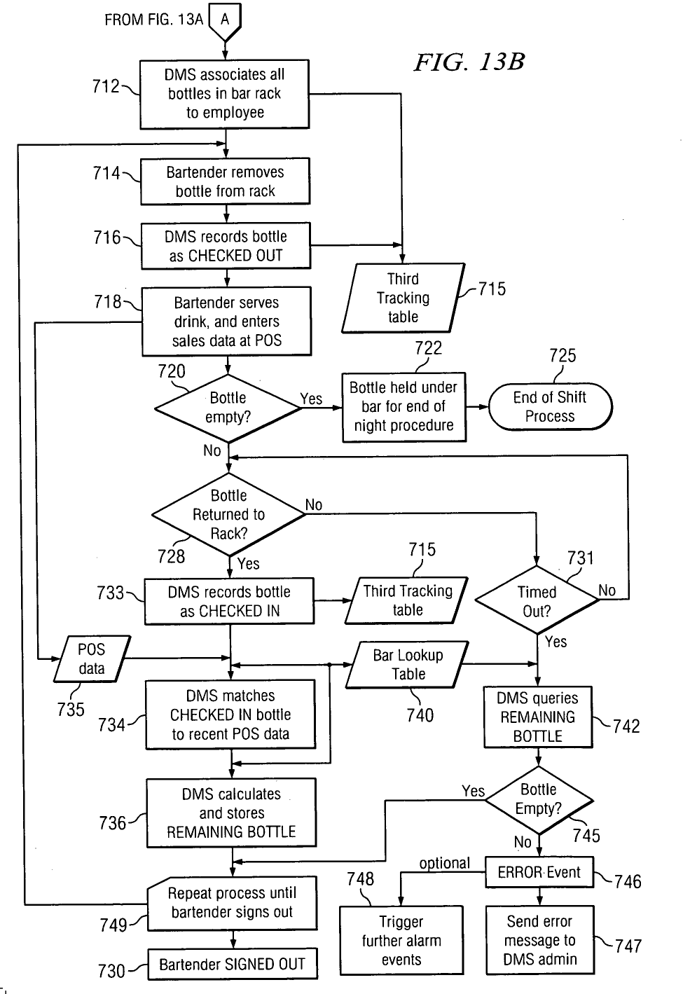

In the case of a bar, inventory may be sold to customers in the forms of shots of liquor from a given bottle which is a single inventory item. It is necessary to track the amount of liquor remaining in all bottles of inventory at all times to detect theft situations. To detect the amount of liquor remaining in a given bottle, the inventory item number of the bottle is associated to sales activity at the point-of-sale device in the bar area in step 672. The percentage of liquor remaining is then updated by DMS 101. The association process of step 672 is shown in FIGS. 13A and 13B and described below.

End of shift process, step 674 provides for further detection of theft activity. An employee recognizes the empty bottles, broken bottles, and remaining levels of open inventory and manually enters the data into the POS system. If discrepancies are determined between the manually entered data and the POS data, variance reports are generated and the variances are associated to the last bartender on duty. FIG. 14 shows the end of shift process of step 674.

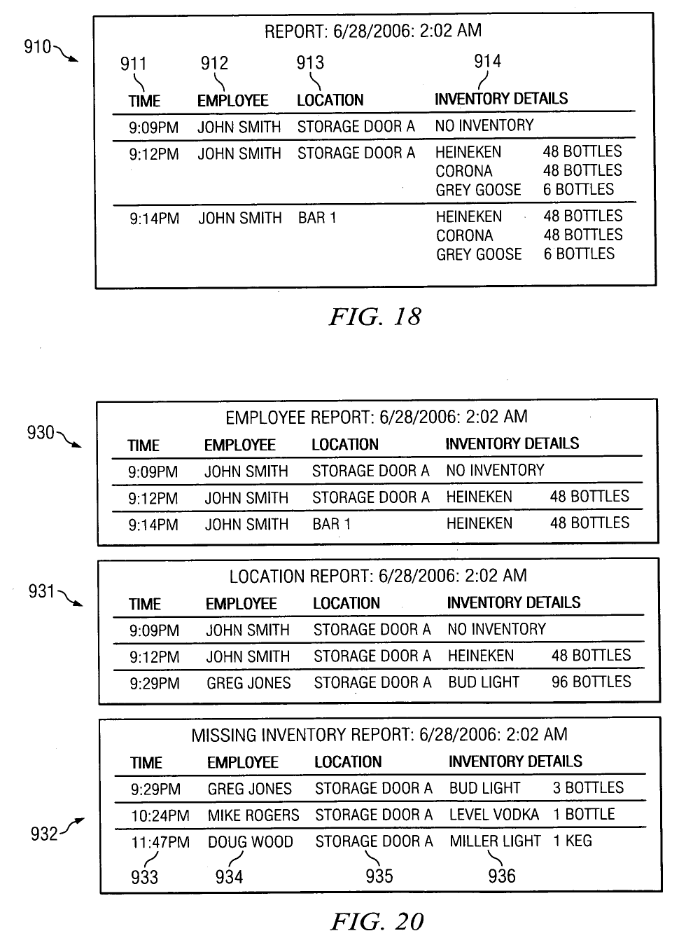

With the associations made in step 660 and step 672, and potentially stolen inventory items being identified in step 674, a set of inventory and variance reports 675 may be generated in step 676. Reports 675 indicate the associations to management so that management may make informed decisions about the assignment of stolen inventory to employees or otherwise. FIGS. 18 through 22 are examples of reports 675.

FIG. 7 is a flowchart of the smart card sign in and sign out process. Process 300 begins with step 302 where an employee swipes a smart card in his possession at an entrance to a stock room door or bar area. The smart card data including ID is read and sent to DMS 101 for validation. The smart card ID is checked for validity in step 305, by examining the first lookup table 307 and employee database (not shown). If the smart card ID is not valid, then access is denied in step 308. If the smart card ID is valid, the employee is checked for SIGNED-IN status in step 310. If SIGNED-IN already, then a security camera is optionally activated in step 311. If not SIGNED IN, then in step 314 the DMS records a SIGNED-IN event in first tracking table 315. The DMS then checks employee credentials in step 317 which are checked for validity in step 320.

In step 320, if the employee does not have credentials to check-in or check-out bottles, then the security camera system is activated in step 321. The method continues in step 323 when the employee swipes his smart card at the exit to a stock room door or bar area. Smart card ID is then sent to DMS in step 324. The smart card ID is validated in step 325. If the employee is not SIGNED-IN or is already SIGNED-OUT in step 329, then an ERROR event is generated in step 330 followed by activation of the security camera system 332 and an optional error handling step 333. The optional error handling step may include utilizing third party security monitoring systems. If the smart card ID is validated in step 325, then in step 328, the DMS records a SIGNED-OUT event in the first tracking table 315.

FIG. 8 is a flowchart diagram of a stock room check out event and the method to handle such an event. Beginning with step 351, the controller queries a given TESU for an RFID data update. In step 352, if data is ready from a prior query, then in step 354 RFID data 355 previously read is sent to the controller. If data needs to be updated, then in step 358, the given TESU probes all the RFID tags for the set of items in proximity to it. If there is no transmission error via step 360, then RFID data 355 is sent to controller in step 361. Should a transmission error occur, a BAD READ event is signaled and the given TESU restarts the probe in step 358. Once the the data is sent to the controller, the controller forwards the fresh RFID data to the DMS in step 363.

The fresh RFID data is compared, in step 365, with RFID data in second lookup table 370. If the RFID data has not changed since the last query, then in step 390, the DMS records the time of the query and a NO CHANGE event in the second tracking table 392. In this case, the query ends at step 395.

If the fresh RFID data has changed since the last query and a bottle RFID tag is missing, then in step 367, a MISSING BOTTLE TAG event is recorded by DMS 101 in second tracking table 392. Step 368 follows when the DMS sends a MISSING BOTTLE TAG signal to the controller. In step 371, the controller sends the MISSING BOTTLE TAG signal to the given TESU which activates a red light on the given TESU in step 372. In step 373, a timeout parameter N is set and the process continues with step 375 wherein the missing RFID tag is probed. If missing RFID tag is still, absent then the timeout parameter N is decremented in step 377. Step 375 repeats, also checking if N is non zero. If N=0, then the process times out and the controller signals a CHECKED-OUT event, location, and time to DMS, logging the event in second tracking table 392. Lookup table 370 is updated in step 380 to reflect the new bottle configuration in the given TESU, the inventory database is updated in step 382, and the process completes in step 385.

Alternatively, if in step 375, the missing bottle tag RFID is detected before timing out, then the bottle has been returned to the storage unit and the controller signals to change the MISSING BOTTLE TAG status to NO CHANGE status, which is recorded by second tracking table 392.

FIG. 9 is a flowchart diagram of the CHECKED OUT event handling process 400. Bottle ID 402 is a bottle that has been previously checked out of the TESU. After the CHECKED OUT event 385 occurs in process 350, then step 403 is executed by the DMS which queries tracking table 404 for all SIGNED IN events in a given time period. In step 410, if there is no SIGNED IN employees for that location, then an ERROR event is signaled in step 412 followed by sending an error message to the DMS administrator 414 and optionally triggering further alarm events in step 415 which may include turning on a security camera. In step 418, if only one employee has SIGNED IN status then in step 419 the employee ID 417 is associated to the bottle ID 402. Optionally, step 420 may be included which validates employee ID 417 CHECK OUT credentials using employee database 425. If invalid, step 421 sends an alert message to the DMS administrator.

If there is more than one employee SIGNED IN then a further check is performed to determine CHECK OUT credentials in step 427. If only one of the SIGNED IN employees has CHECK OUT credentials then that employee ID is associated to bottle ID 402 in step 428.

If no employee has valid credentials, then in step 432, the senior most SIGNED IN employee with employee ID 436 is associated to bottle ID 402. If multiple employees are in the location with SIGNED IN status with valid CHECK OUT credentials, then in step 429, the employee ID with the most recent SIGNED IN event is associated to bottle ID 402.

After any of association steps 428, 429 or 432, the employee associated to bottle ID 402 leaves the location and is switched to SIGNED OUT status according to process 300.

Under normal circumstances, inventory transfers from the holding area to a stock room or from a stock room to a bar area, cause a CHECKED IN event to occur. FIG. 10 shows the general CHECK IN process 450. Beginning with step 451, the controller queries a given TESU for an RFID data update. In step 452, if data is ready from a prior query, then in step 454 RFID data 455 previously read is sent to the controller. If data needs to be updated then in step 458, the given TESU probes all the RFID tags for the set of bottles associated to it. If there is no transmission error via step 460 then RFID data 455 is sent to controller in step 461. Should a transmission error occur, a BAD READ event is signaled and the given TESU restarts the probe in step 458. Once the data is sent to the controller, the controller forwards the fresh RFID data to the DMS in step 463.

The fresh RFID data is compared, in step 465, with RFID data in lookup table 470. If the RFID data has not changed since the last query, then in step 492, the DMS records the time of the query and a NO CHANGE event in tracking table 475. In this case, the query ends at step 495.

If the fresh RFID data has changed since the last query and a bottle RFID tag is newly added, then a NEW BOTTLE TAG event is issued in step 467. The NEW BOTTLE TAG event causes an update to lookup table 470 in step 480, using the inventory database 490 to find the attributes associated to the new bottle tag. In step 468, the DMS sends a NEW BOTTLE TAG signal to the controller which in turn, in step 474 forwards the NEW BOTTLE TAG signal to the TESU. The controller then signals a CHECKED IN event in step 479 which creates a record in tracking table 475 to log the CHECKED IN event including time, location, and bottle RFID. Inventory database 490 is updated in step 482 to show CHECKED IN status for the bottle. The CHECKED IN process concludes in step 485.

Turning now to the bar management process, FIG. 11 is a flowchart diagram of a bar area inventory process 550 which begins with step 551 when an employee carries at least one CHECKED OUT bottle to a given bar area. The employee then swipes his smart card outside the bar area in step 553 after which the smart card data including ID is read and sent to the DMS for validation. The smart card ID is checked for validity in step 555, by examining the first lookup table 558 and employee database (not shown). If the smart card ID is not valid, then a security camera is activated in step 560. If the smart card ID is valid, the employee is checked for SIGNED-IN status in step 559. If SIGNED-IN already, then a security camera may be activated in step 560. In step 562 the DMS records a SIGNED-IN event in first tracking table 570.

Once the employee is SIGNED IN to the bar area, he places the CHECKED OUT bottle in the bar area rack in a TESU in step 564. The DMS performs a query on the bar area TESUs in step 566 which initiates a bar area CHECK IN process 568 similar to CHECK IN process 450 described previously. CHECK IN process 568 results in the bottle RFID tag being included in bar lookup table 580 and a CHECKED IN event recorded with time, location, and bottle RFID in third tracking table 590.

As CHECKED OUT inventory leaves stock room it is a method of the present invention to monitor the CHECKED OUT items and send alerts to management if inventory is not CHECKED IN after a predefined time period. The timing out process 600 to accomplish said method is shown in the flow chart of FIG. 12. Timing out process 600 is run continuously as a background process in the DMS computer. In step 601, the DMS queries the stock room tracking table and second tracking table 602 for CHECKED OUT events. In step 605, the DMS monitors the bar area tracking table and third tracking table 606 for CHECKED IN events.

In step 610, an attempt is made by the DMS to match a CHECKED OUT event to a CHECKED IN event. If a match is found, step 610 is performed for another CHECKED OUT event. If no match is found, then the elapsed time E is computed in step 612 as the difference between the current time and the CHECKED OUT event time recorded in the tracking table. In step 615, the elapsed time E is compared to a preset transfer time T 617. If elapsed time E is less than T, then step 610 is repeated for another CHECKED OUT event. If elapsed time E is greater than or equal to T, then in step 620, an error event is logged in first tracking table 622 for SIGNED OUT employee associated to CHECKED OUT event noting the CHECKED OUT inventory, a timed out designation, the current time, and the elapsed time. Optionally, in step 625, an alert may be generated and sent to a manager on duty for example to a specified pager device phone number or email address so that the manager may know to take rectifying action.

FIGS. 13A and 13B are a flowchart of a bar service management process 700. In step 701, bar service begins when an employee, usually a bartender, swipes a smart card in the bar area. The smart card ID is sent to the DMS in step 703 and validated by the DMS in step 705 using employee lookup table 706 and employee database (not shown). If the card ID is invalid, a security camera is activated in step 709. If the card ID is valid then the employee ID associated to the card ID is checked for bartender credentials in step 708. The DMS records the employee as SIGNED IN with bartender credentials in step 710. The card reader may be integrated into the POS device in the bar area, so that the bartender is simultaneously logged into the POS system. Furthermore, a different card reader may be utilized for employees that are simply moving inventory into the bar area as in process 550. Process 700 is continued at point A on FIG. 13B.

In FIG. 13B, step 712 is performed after the bartender is SIGNED IN. Step 712 associates all bottles in the bar area rack to the bartender. This association is recorded as an event in third tracking table 715. Later, after accepting an order from a customer, the bartender removes a bottle from the rack in step 714. This action causes the DMS to record the bottle with a given bottle ID as CHECKED OUT, the event being recorded in third tracking table 715. The bartender then mixes and serves the drink after which he enters sales data at the POS in step 718. The POS event is recorded in POS data 735. If the bottle is empty, then in step 720, the bartender places the empty bottle including its bottle RFID tag under the bar in step 722 for an end of shift process 725. The bar service management process 700 continues in any case with step 728.

Once the bottle is determined by the bartender to have remaining content, the bottle is returned to the bar rack at step 728. This may be done immediately after the POS or some time thereafter according to the work flow of the bartender. However, steps 728 and 731 perform a timed out process to capture situations where bottles may not have been returned or in fact may have been taken out of the bar in an unauthorized way. If the bottle is not returned to the rack after a preset time period checked by step 731, then in step 742 the DMS queries the bar lookup table 740 for the REMAINING BOTTLE attribute of the given bottle ID. The result of step 742 is checked in step 745 to determine if the bottle is empty. If empty, the process continues at step 749 and it is assumed that the bottle has been held under the bar in step 722. If the bottle is not empty in step 745, an ERROR event is initiated in step 746 followed by sending a message to the DMS administrator in step 747. In step 748, further alarm events may be triggered such as paging the bartender.

After the bottle is returned to the rack, in step 733, the DMS records the bottle as CHECKED IN. The event is recorded in third tracking table 715. In step 734, the DMS matches the CHECKED IN bottle ID to recent POS data by querying the bar lookup table 740 and POS data 735. POS data 735 includes the amount of liquor used in mixing the drink, so in step 736 the DMS calculates and stores the amount of liquor remaining in the bottle as REMAINING BOTTLE attribute in bar lookup table 740.

According to step 749, process 700 repeats at step 714 until the bartender SIGNS OUT by swiping his smart card in step 730. The SIGNED OUT event of step 730 is recorded in the personnel tracking table as in process 300.

End of shift procedure 800 occurs after each bartender shift. The next on-duty bartender or manager must ascertain or recognize inventory with no remaining contents, broken inventory, and the current levels of the open inventory. As bar prep before each shift, the bartender or manager manually enters into the POS system recognized empty bottles, recognized broken bottles, and the current levels of the open inventory behind the bar. The bartender visually observes each bottle and estimates the level of each bottle to the nearest tenth. The POS system converts the tenths into ounces. This information is reconciled with the POS data accumulated throughout the previous shift and discrepancies are noted. Discrepancies can be caused by over-pouring or under-pouring by bartenders, unauthorized pouring not related to sales, purchases unfulfilled (dropped drinks), inaccurate recipes in the POS system, or theft of inventory. Variance reports are created identifying the discrepancies. In an alternate embodiment where employees carry RFID tagged ID badges or smart cards, the discrepancies can be associated to the employees on duty at the time. The end of shift procedure is represented by step 674 of FIG. 6 and step 834 of FIG. 15.

FIG. 14 shows the steps involved in end of shift procedure 800. End of shift procedure 800 begins with step 801 wherein an employee records data in bar lookup table 805 showing that the bottles underneath the bar are EMPTY. The recording may be accomplished by a computer terminal connected to the DMS. The employee may also record, in step 803, any broken bottles that may have resulted in lost contents that should be accounted for. A BROKEN BOTTLE attribute is recorded in bar lookup table 805. In step 804, the employee will also record the levels of open inventory in bar lookup table 805.

Step 807 reconciles the entries in POS data 810, third tracking table 815, and bar lookup table 805 by comparing the manually entered data to the POS data acquired throughout the shift. Discrepancies in the inventory levels are identified in step 808. In an alternate embodiment, step 812 associates the discrepancies to the last bartender to have CHECKED OUT each bottle showing a variance.

Events and updates occur for each stock room and for each bar area associated to the premises according to the movement of inventory about the premises. Each update has an associated log message which is sent to data management system 101 so that a complete inventory log is kept of all inventory transactions. Data management system 101 may then run programs to query and run various reports based on the information in inventory database 240, in a system log, in an inventory log, and in tracking tables 222, 224, and 226. Queries of the inventory log, system log and tracking tables are used to generate report views as described below.

FIG. 18 shows a report view of a first example of an inventory event report 910 generated by data management system 101. The central computer is used to produce simple reports and also to set off alarms in the event inventory is not accounted for within a stipulated timeframe. This ensures that the staff who brings out the inventory from the stock room deliver the inventory directly to the bar areas immediately without diversion. Event report 910 indicates the time 911 of each inventory event, the employee 912 involved in the inventory event, the location 913 of the inventory event, and some detailed text 914 describing the inventory event. Event report 910 is a simple report based on the information in the inventory log. This report allows a “forensic study” into the event from the time the staff enters the stock room to the time the inventory is accounted for. Every event is time stamped. Alarms will be raised if inventory is not accounted for within a stipulated timeframe from the time the staff leaves the stock room.

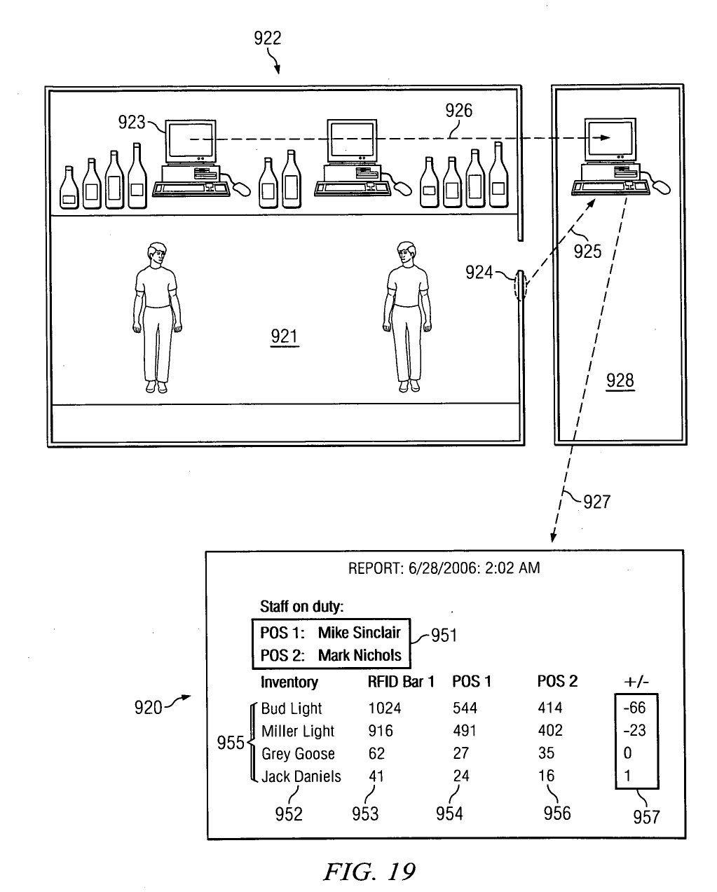

FIG. 19 shows a graphic of a set bar area events 922 and a report view of a second example of an inventory event report 920. Bar area 921 receives inventory which is read by RFID scanner 924 and for which a plurality of inventory updates 925 are sent to central computer 928. A plurality of sales are made in bar area 921 at POS position 923 wherein a plurality of sales updates 926 are sent data management system 101. A manager requests a report view of data management system 101 which is computed and displayed 927 as report view 920. Report view 920 includes employees 951 logged into the POS positions in bar area 921 and a set of records 955. Report view 920 displays one record for each type of inventory including the fields inventory 952 sold from bar area 921, number of items 953 received into bar area 921 inventory, number of items sold from first POS 954, number of items sold from second POS 956, and discrepancy 957. Discrepancy 957 is the difference between the items received and the total items sold. A manager may easily recognize if inventory is missing from the bar area by examining the set of records 955.

FIG. 20 shows three report views, employee report 930, location report 931, and missing inventory report 932. Each report view has one record per row, each record indicating: time 933, an employee attached to a given inventory 934 at time 933, a location of where the inventory was logged with the employee 935, and inventory details 936 including types and numbers of items. Employee report 930 is useful for monitoring suspicious activity and is constructed by querying the inventory database 105 for all events involving a particular employee for a given time period. The location report 931 is useful for monitoring locations prone to inventory loss and is constructed by querying the inventory database 105 for events involving a particular location. Missing inventory report 932 is a summary report generated by one of the following query methods: by querying missing inventory table 270, by querying employee inventory table 230 for in hand items still associated with employees, or by performing a query on the overall inventory database 105 which totals inventory and subtracts the inventory sold by inventory type.

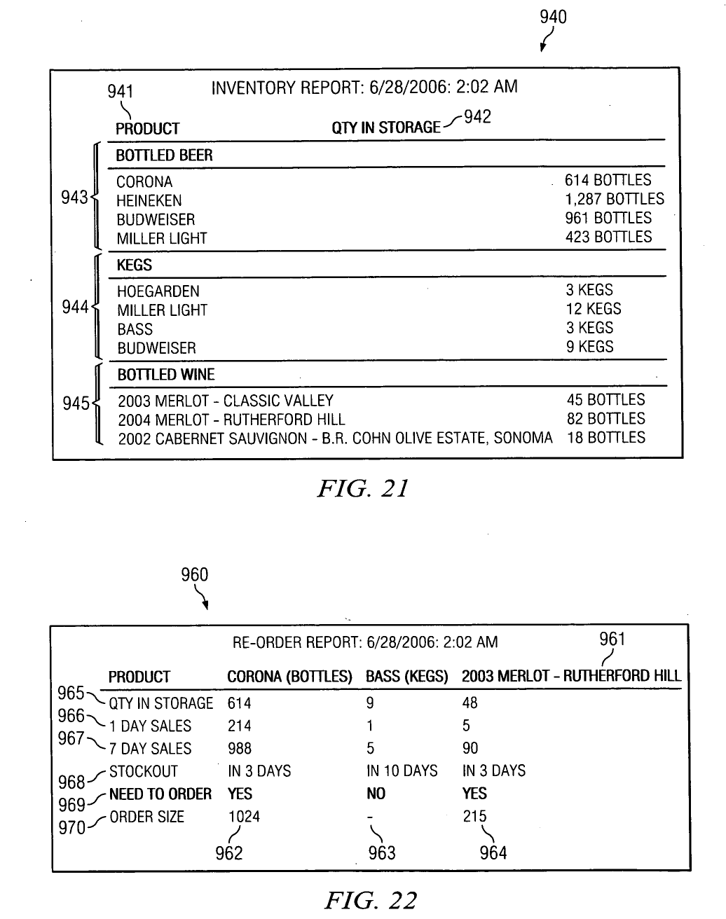

FIG. 21 shows a report view of current inventory report 940. Inventory report 940 is a total of all inventory on the premises constructed by performing a query on the overall inventory database 105 to sum the inventory by inventory type. Inventory report 940 separates the inventory types into tables 943, 944, and 945. Each table includes product type field 941 and product quantity field 942.

The present invention is also useful for inventory management functions outside of theft deterrence. FIG. 22 shows a view of a re-order report 960 constructed by querying inventory database 105. Columns 962, 963, and 964 are associated with specific bar area products, in this example, Corona, Bass, and 2003 Merlot—Rutherford Hill respectively. Row 961 is the header row of the report and identifies the specific product. Row 965 contains total quantities of product in storage. Row 966 contains sums of sales for the previous day. Row 967 contains sums of sales for the previous week. Row 968 contains estimates of when stock will be depleted by computing a sales trend for each product. Row 969 contains a simple ‘yes’ or ‘no’ and indicates whether or not to reorder. Finally, Row 970 estimates an order quantity based on the sales trend.

While this preferred embodiment has been described in reference to a preferred embodiment, this description is not intended to be construed in a limiting sense. Various modifications and combinations of the illustrative embodiments, as well as other embodiments of the preferred embodiment, will be apparent to persons skilled in the art upon reference to the description. It is therefore intended that the appended claims encompass any such modifications or embodiments.

1. A system for tracking inventory and deterring theft when inventory is transferred from a first location to a second location within the premises of a food and beverage serving retail establishment comprising:
a data management system having a data structure and a set of programmed mechanisms and connected to a set video surveillance cameras, where the set of video surveillance cameras are mounted to the first location and the second location;
a first rack system located at the first location and connected to the data management system;
a second rack system located at the second location and connected to the data management system;
a point of sale terminal connected to the data management system; and, a set of RFID tags applied to the inventory.

2. The system for tracking inventory and deterring theft of claim 1 wherein the first rack system and the second rack system each comprise:
a controller in communication with the data management system;
a multiplexor connected to and in communication with the controller;
at least one storage unit having a transceiver communicatively connected to the set of RFID tags and communicatively connected to the multiplexor; and,
wherein each rack system queries the set of RFID tags and when changes are detected sends messages to the data management system.

3. The system for tracking inventory and deterring theft of claim 1 wherein:
the data structure has at least an inventory database and the set of programmed mechanisms includes;
a first location event tracking mechanism having a first lookup table in communication with the first rack system and a first tracking table in communication with the first rack system; and,
a second location event tracking mechanism having a second lookup table in communication with the second rack system and a second tracking table in communication with the second rack system.

4. The system for tracking inventory and deterring theft of claim 1 wherein the inventory includes wine bottles, liquor bottles, cases of beer, and kegs of beer and wherein at least one of the set of RFID tags is integrated into a label adhered to at least one wine bottle, liquor bottle, case of beer, or keg of beer.

5. The system for tracking inventory and deterring theft of claim 1 wherein the data management system is located external to the premises of a food and beverage serving retail establishment.

6. A system for inventory tracking and theft deterrence for when an employee transfers an item from a first location to a second location comprising:
a data management system resident on a computer and having a data structure and a set of programmed functions, where the computer is electronically connected to a first storage unit, a second storage unit, a first video camera, a second video camera, and a point of sale register;
an RFID tag attached to the item located in the first location;
wherein the first video camera is located at and continuously records the first location and the second video camera is located at and continuously records the second location;
wherein the first storage unit is located in the first location and includes a first controller electronically connected to the computer, a first multiplexor electronically connected to the first controller, and a first transceiver electronically connected to the first multiplexor, where the first transceiver detects the RFID tag when the RFID tag is proximate the first storage unit;
wherein the second storage unit is located in the second location and includes a second controller electronically connected to the computer, a second multiplexor electronically connected to the second controller, and a second transceiver electronically connected to the second multiplexor, where the second transceiver detects the RFID tag when the RFID tag is proximate the second storage unit;
wherein the set of programmed functions checks out the item from the first location when the first storage unit no longer detects the RFID tag;
wherein the set of programmed functions checks in the item to the second location when the second storage unit detects the RFID tag and records a transfer time; and,
wherein the set of programmed functions saves video captured by the first video camera when the transfer time is greater than a predetermined allowable transfer time.

7. A method of tracking inventory and deterring theft of inventory when an employee moves inventory from a first location to a second location, the method comprising the steps of:
providing a data management system resident on a computer and having a data structure and a set of programmed functions, where the computer is electronically connected to a first transceiver enabled storage unit located in the first location, a second transceiver enabled storage unit located in the second location, a first video camera mounted at the first location, a second video camera mounted at the second location, and a point of sale register;
providing RFID tags implanted on the inventory;
monitoring the first transceiver enabled storage unit to determine contents;
removing the inventory from the first transceiver enabled storage unit;
updating the inventory to CHECKED OUT status;
delivering the inventory to second transceiver enabled storage unit;
monitoring the second transceiver enabled storage unit to determine contents;
updating the inventory to CHECKED IN status; and,
creating reports.

8. The method of tracking inventory and deterring theft of inventory of claim 7 further comprising the steps of:
querying the data management system to determine all CHECKED OUT events from the first location;
monitoring the data management system for all CHECKED IN events at the second location;
matching CHECKED OUT events with CHECKED IN events;
calculating a first elapsed time of all matched CHECKED OUT events;
comparing the first elapsed time with a predefined acceptable transfer time;
logging an error event in the data management system, creating an alert message, and saving a video file captured from the first location when the first elapsed time is greater than the predefined acceptable transfer time;
calculating a second elapsed time of all unmatched CHECKED OUT events;
comparing the second elapsed time with the predefined acceptable transfer time;
logging an error event in the data management system, creating an alert message, and saving a video file captured from the first location when the second elapsed time is greater than the predefined acceptable transfer time; and,
creating reports.

9. The method of tracking inventory and deterring theft of inventory of claim 7 further comprising the steps of:
manually recording inventory with no remaining contents;
manually recording broken inventory;
manually recording levels of open inventory;
reconciling point of sale information with the manually recorded inventory with no remaining contents, the manually recorded broken inventory, and the manually recorded levels of open inventory; and,
identifying discrepancies.

10. A system for tracking inventory and deterring theft by assigning inventory to an employee when inventory is transferred from a first location to a second location within the premises of a food and beverage serving retail establishment comprising:
a data management system having a data structure and a set of programmed mechanisms and connected to a set of smart card readers, where the set of smart card readers are mounted to the first location and the second location;
a first rack system located at the first location and connected to the data management system;
a second rack system located at the second location and connected to the data management system;
a smart card attached to the employee and when proximate the set of smart card readers is detectable by the set of smart card readers;
a point of sale terminal connected to the data management system; and,
a set of RFID tags applied to the inventory.

11. The system for tracking inventory and deterring theft of claim 10 wherein the first rack system and the second rack system each comprise:
a controller in communication with the data management system;
a multiplexor connected to and in communication with the controller;
at least one storage unit having a transceiver communicatively connected to the set of RFID tags and communicatively connected to the multiplexor; and,
wherein each rack system queries the set of RFID tags and when changes are detected sends messages to the data management system.

12. The system for tracking inventory and deterring theft of claim 10 wherein:
the data structure has at least an employee database and an inventory database; and,
the set of programmed mechanisms includes;
a personnel event tracking mechanism having a first lookup table in communication with the set of smart card readers and a first tracking table in communication with the set of smart card readers;
a first location event tracking mechanism having a second lookup table in communication with the first rack system and a second tracking table in communication with the first rack system; and,
a second location event tracking mechanism having a third lookup table in communication with the second rack system and a third tracking table in communication with the second rack system.

13. The system for tracking inventory and deterring theft of claim 10 wherein the point of sale terminal is electronically connected to at least one smart card reader of the set of smart card readers.

14. The system for tracking inventory and deterring theft of claim 10 wherein the first location includes a camera connected to the data management system and the second location includes a camera connected to the data management system.

15. The system for tracking inventory and deterring theft of claim 10 wherein the inventory includes wine bottles, liquor bottles, cases of beer, and kegs of beer and wherein at least one of the set of RFID tags is integrated into a label adhered to at least one wine bottle, liquor bottle, case of beer, or keg of beer.

16. The system for tracking inventory and deterring theft of claim 10 wherein the data management system is located external to the premises of a food and beverage serving retail establishment.

17. The system for tracking inventory and deterring theft of claim 10 wherein the set of smart card readers is replaced by a set of RFID readers and the smart card attached to the employee is replaced by an RFID tagged badge.

18. A system for inventory tracking and theft deterrence when an employee with a smart card transfers an item from a first location to a second location comprising:
a data management system resident on a computer and having a data structure and a set of programmed functions, where the computer is electronically connected to a first storage unit, a second storage unit, a first card scanner, a second card scanner, and a point of sale register;
an RFID tag attached to the item located in the first location;
wherein the first card scanner is located proximate the first location and the second card scanner is located proximate the second location;
wherein the first storage unit is located in the first location and includes a first controller electronically connected to the computer, a first multiplexor electronically connected to the first controller, and a first transceiver electronically connected to the first multiplexor, where the first transceiver detects the RFID tag when the RFID tag is proximate the first storage unit;
wherein the second storage unit is located in the second location and includes a second controller electronically connected to the computer, a second multiplexor electronically connected to the second controller, and a second transceiver electronically connected to the second multiplexor, where the second transceiver detects the RFID tag when the RFID tag is proximate the second storage unit;
wherein the set of programmed functions associates the item with the employee when the first card scanner reads the smart card and the first storage unit detects the RFID tag is missing; and,
wherein the set of programmed functions checks in the item to the second location when the second card scanner reads the smart card and the second storage unit detects the RFID tag.

19. The system for inventory tracking and theft deterrence of claim 18 wherein the second card scanner is electronically connected to the point of sale register.

20. The system for inventory tracking and theft deterrence of claim 18 wherein a set of cameras are connected to the computer and located at the first location and at the second location.

21. A method of tracking inventory and deterring theft of inventory when an employee moves inventory from a first location to a second location, the method comprising the steps of:
providing a data management system resident on a computer and having a data structure and a set of programmed functions, where the computer is electronically connected to a first transceiver enabled storage unit located in the first location, a second transceiver enabled storage unit located in the second location, a first card scanner mounted at the first location, a second card scanner mounted at the second location, and a point of sale register;
providing RFID tags implanted on the inventory;
providing a smart card containing identification information to the employee;
swiping the smart card at the first card scanner;
identifying the employee as SIGNED IN to the first location;
monitoring the first transceiver enabled storage unit to determine contents;
removing the inventory from the first transceiver enabled storage unit;
updating the inventory to CHECKED OUT status;
associating the CHECKED-OUT inventory to the employee;
swiping the smart card at the first card scanner;
identifying the employee as SIGNED OUT from the first location;
delivering the inventory to second transceiver enabled storage unit;
monitoring the second transceiver enabled storage unit to determine contents;
updating the inventory to CHECKED IN status; and,
creating reports.

22. The method of tracking inventory and deterring theft of inventory of claim 21 further comprising the steps of:
querying the data management system to determine all CHECKED OUT events from the first location;
monitoring the data management system for all CHECKED IN events at the second location;
matching CHECKED OUT events with CHECKED IN events;
calculating a first elapsed time of all matched CHECKED OUT events;
comparing the first elapsed time with a predefined acceptable transfer time;
logging an error event in the data management system when the first elapsed time is greater than the predefined acceptable transfer time;
creating an alert message when the first elapsed time is greater than the predefined acceptable transfer time;
calculating a second elapsed time of all unmatched CHECKED OUT events;
comparing the second elapsed time with the predefined acceptable transfer time;
logging an error event in the data management system when the second elapsed time is greater than the predefined acceptable transfer time;
creating an alert message when the second elapsed time is greater than the predefined acceptable transfer time; and,
creating reports.

23. The method of tracking inventory and deterring theft of inventory of claim 21 further comprising the steps of:
manually recording inventory with no remaining contents;
manually recording broken inventory;
manually recording levels of open inventory;
reconciling point of sale information with the manually recorded inventory with no remaining contents, the manually recorded broken inventory, and the manually recorded levels of open inventory; and,
identifying discrepancies.

24. The method of tracking inventory and deterring theft of inventory of claim 21 wherein the step of identifying the employee as SIGNED IN further comprises the steps of:
sending employee identification information to the data management system;
validating the smart card;
denying access to the first location if smart card invalid;
checking employee profile for SIGNED IN status;
activating a security camera when the employee already has SIGNED IN status;
recording the employee as SIGNED IN when the employee not already SIGNED IN;
checking employee profile for CHECK OUT credentials for the first location; and
activating a security camera when employee does not have CHECK OUT credentials for the first location;

25. The method of tracking inventory and deterring theft of inventory of claim 21 wherein the step of associating the CHECKED OUT inventory to the employee further comprises the steps of:
querying the data management system to determine SIGNED IN employees in a predefined time period;
creating error message when there are no employees with SIGNED IN status in first location;
associating the CHECKED OUT inventory to SIGNED IN employee when only one employee has SIGNED IN status;
associating the CHECKED OUT inventory to SIGNED IN employee with CHECK OUT credentials if more than one employee has SIGNED IN status;
associating the CHECKED OUT inventory to the most recent SIGNED IN employee with CHECK OUT credentials if more than one SIGNED IN employee has CHECK OUT credentials; and,
associating the CHECKED OUT inventory to the most senior SIGNED IN employee if no SIGNED IN employees have CHECK OUT credentials.
